(19) United States
(12) Patent Application Publication
(10) Pub. No.: US 2015/0165497 A1
(43) Pub. Date: Jun. 18, 2015

(54) APPARATUS FOR REMOVAL OF ALKALINE EARTH METAL SALT SCALE AND METHOD

(71) Applicant: SLD Enhanced Recovery, Inc., Houston, TX (US)

(72) Inventors: Tamas Bozso, Halasi (HU); Robert Bozso, Ovoda (HU)

(21) Appl. No.: 14/412,885

(22) PCT Filed: Jul. 5, 2013
(86) PCT No.: PCT/US2013/049464

§ 371 Date: Jan. 5, 2015

(30) Foreign Application Priority Data
Jul. 5, 2012 (HU) P1200406

(51) Int. Cl. B08B 9/043; B08B 7/00; B08B 9/04

(52) U.S. Cl. CPC B08B 9/043; B08B 9/04; B08B 7/0042

(57) ABSTRACT

A method to remove an alkaline earth metal salt scale deposits from a pipe comprises introducing a laser head (4) into a pipe (1), isolating a pipe section to be cleaned (8) adjacent to a scale deposit (2) on an interior wall of a pipe using a packer (6), filling the section of the pipe to be cleaned (8) with gas to displace laser-obstructing materials, activating a laser element in the laser head (4) to heat a surface layer of the scale deposit (2) above a thermal decomposition temperature, and washing the thermally decomposed scale deposit (2) with water. The thermally decomposed scale deposit (2) becomes at least partially soluble and removable as a result of being heated.

### STATEMENT OF RELATED APPLICATIONS

This application depends from and claims priority to International PCT/US2013/049464 filed on Jul. 5, 2013, which depends from and claims priority to Hungarian patent application no P1200406, tiled on Jul. 5, 2012.

### BACKGROUND

1. Field of the Invention

The present invention relates to the removal of an insoluble scale deposit from an interior wall of a pipe used to transport fluid. More specifically, the present invention relates to an apparatus and a method to remove alkaline earth metal salt scale deposits such as, for example, barium sulfate, from an interior wall of a pipe. Embodiments of the apparatus and method of the present invention may be used to remove material from an interior wall of a pipeline on or just underneath the surface of the earth or from a production tubing in a subterranean well drilled into the earth's crust to recover oil, gas, water or other minerals.

2. Background of the Related Art

Solid scale deposits often form on the interior walls of pipes used to transport fluids. These insoluble scale deposits substantially reduce the cross-sectional flow area of a pipe and may impair the capacity of the pipe to efficiently transport fluids. Prior solutions to the scale problem include the removal of material using physical and chemical means. Some physical removal methods employ mechanical stress or otherwise damage the interior wall of the pipe. Other removal methods employ thermal devices.

U.S. Patent Application Publication 2009/0205675 relates to the melting of solid material using heat generated by a laser. The solid material on the interior wall of the pipe is exposed to laser light. The irradiated scale thermally degrades and is removed by fluid flow through the pipe bore. In this method, the laser beam is used in the medium of the hydrocarbon fluid transported using the pipe, and the moving stream of hydrocarbon fluid removes the thermally degraded solid materials that are shed from the interior wall of the pipe.

Alkaline earth metals are the elements of the second column of the periodic table. In a narrower sense, alkaline earth metals refer to Ca, Sr and Ba because their physical and chemical properties are very similar. Due to their high valence, a very strong electrostatic bond stabilizes ionic salts that include these elements. As a result, earth metal alkali salts having a valence of +2 are substantially insoluble in water. As a result, these materials tend to form insoluble precipitates and scales in pipes.

Typical examples of such problematic precipitates include, but are not limited to, CaCO₃, SrCO₃, BaCO₃, CaSO₄, BaSO₄, SrSO₄, BaSO₄ and mixture crystals of these compounds. Due to their extreme insolubility, CaCO₃, CaMg(CO₃)₂ and BaSO₄ are particularly common. A low occurrence of phosphate in the environment is the reason that scales and deposits of phosphate salts are less common.

Carbonate salts are soluble in acid, but sulfate salts are not. The more rare phosphate salts can be made soluble only in extremely acidic conditions. All of these salts are susceptible to thermal decomposition at temperatures beginning at about 1000 K in the case of solid carbonate salts, and much higher for sulfate salts and phosphate salts. Decomposition of sulfate salts can be facilitated by chemical reduction as well, through which we can create more soluble sulfides, which are readily soluble in an acidic medium, with the formation of hydrogen sulfide.

Chemical methods have been proposed for chemically dissolving or otherwise degrading the scale. These chemical methods work best for carbonate scales. For scales containing alkaline earth metal sulfates and phosphates, chemical removal procedures have been attempted, but with limited success. U.S. Pat. No. 5,282,995 provides a process in which a chemical solution having, a specific composition is applied to the scale material to slowly solubilize or dissolve scales comprising an earth metal sulfate. U.S. Pat. No. 5,190,656 provides a method involving the use of chelating and acidifying amino acids and co-catalysts. Chelating is an inefficient solution for alkali sulfates because they are water-insoluble in the unaltered state. Procedures recited in U.S. Pat. No. 4,215,000 and U.S. Pat. No. 4,288,333 refer to dissolving scale deposits in such a manner. U.S. Pat. No. 6,382,423 provides a liquid-phase reduction.

International Patent Application Publication WO 2009/103943 provides a method for using a laser to clean a pipe including the step of introducing a laser head into the bore of the pipe to be cleaned. The laser head is controllably moved through the bore of the pipeline using mechanical force. Laser beams emitted from a leading end of the laser head are directed to impinge onto the scale adhered to the interior pipe wall, and the irradiated scale deposits are either vaporized or evaporated by the heat of the laser light, or the irradiated scale deposits are thermally degraded to a condition permitting removal from the pipe wall by conventional mechanical means (pigging, washing, etc.). In this method, the laser beam impinges upon the scale deposits because the section of the pipe containing the laser head is provided with a volume of non-laser-obstructing fluid introduced to promote laser light transmission from the laser head to the interior pipe wall or to the scale deposited on the interior pipe wall. One shortcoming, of this solution is that a very large amount of power is needed to produce a laser light with sufficient intensity to vaporize, evaporate or thermally degrade the scale deposits. Another shortcoming of this solution is complexity and difficulty of providing an apparatus that can precisely move and position the laser head within the bore of the pipe and along the interior wall of the pipe. Absent precise positioning and movement, removing scale using laser-generated heat alone provides unpredictable and uneven results, thereby requiring multiple passes and/or frequent cleaning.

U.S. Pat. No. 7,591,310 introduces a method of hydro-treating a liquid stream to remove clogging compounds, proposing the removal of clogging compositions from the interior wall of the pipe through a liquid stream produced specifically for this purpose. The feasibility of this method for the removal of alkaline earth metal salt scale is highly questionable, and it is inefficient.

The thermic conversion of alkaline earth metal salts requires very high temperature (1000-2000 K) which can be produced easily with a laser beam in a gas phase. However, producing such temperatures using, a laser beam operating in a liquid environment is not feasible due to the loss of a substantial amount of energy through the boiling (vaporization) of the liquid material through which the laser beam passes.

What is needed is a system that enables a laser head to impinge laser light onto a scale material adhered to the interior wall of a pipe with sufficient energy transfer to the scale material to produce a temperature sufficient for scale removal. Such energy transfer requires that the section of the bore of the pipe in which scale material is to be removed must contain a non-laser light obstructing gas.

### SUMMARY OF THE INVENTION

Embodiments of the present invention provide an apparatus and a method for removing rare earth metal salt scale deposits from the interior wall of a pipe used to transport fluids. More specifically, embodiments of the present invention provide an apparatus and a method for thermally degrading or decomposing at least a component of rare earth salt scale deposit on the interior wall of a pipe used to transport fluids. The method comprises irradiating the scale deposit to thereby thermally destabilize a surface layer of the scale deposit, and then washing the partially molten layer and/or thermally degraded layer from the remaining portion of the scale deposit and/or from the interior wall of the pipe using water, and then recombining at least two of the products resulting from the steps of melting and/or thermally degrading and then washing with water.

The effectiveness of the method is best understood by analyzing the chemical transformations that occur at each step. For example, the thermal decomposition of carbonate salts (using heat provided by laser light) is generally described by: CaCO₃→CaO+CO₂. The resulting carbon dioxide is liberated from the reaction environment in a gas phase, while CaO, or lime, reacts immediately when exposed to water as described by: CaO+H₂O→Ca(OH)₂. The resulting water-soluble “slaked lime” is readily water-leachable from the location of the scale deposition and thus removable from an interior wall of a pipe.

The solubility of CaCO₃, or limestone, is less than that of CaSO₄, or gypsum. These are therefore the most common calcium salt deposits. However, the reverse is true with barium salts; that is, the solubility of BaSO₄ is less than that of BaCO₃. As a result, in the case of barium salts, the most common is the sulfate salt form, BaSO₄. Strontium forms a transition and, due to its relative rarity, it replaces the calcium or barium in the abovementioned salts.

Another embodiment of the invention provides an apparatus for thermally decomposing sulfates. For example, barium sulfate melts at temperatures around I800-2000 K, and decomposes according to: BaSO₄→BaO+SO₃. The resulting sulfur trioxide is liberated from the reaction environment as a gas phase, while the remaining BaO reacts immediately upon contact with water according to: BaO+H₂O→Ba(OH)₂. The resulting water-soluble barium hydroxide is easily dissolved and removed from an interior wall of a pipe by flowing water through the bore of the pipe. When the liberated sulfur trioxide gas contacts water, it immediately converts to sulfuric acid according to: H₂O+SO₃→H₂SO₄. The sulfuric acid reacts immediately with the barium hydroxide according to: Ba(OH)₂+H₂SO₄→BaSO₄+2 H₂O. It is important to note that the original barium sulfate scale material is removed from the interior wall of the pipe and transformed, by heat-enabled chemical reactions provided above, from an insoluble solid material on the interior wall of the affected pipe to an aqueous solution.

It is important to note that sulfur trioxide is a gas at high temperatures, and if the sulfur trioxide is liberated from the reaction environment in the as phase, thereby removing it from the reaction zone and preventing it from reacting with the Ba(OH)₂. As a result, the reversion to Ba(OH)₂, or the “recombination” step, will not occur until these two materials are recombined. This recombination step can occur in a controlled manner in a designated recombination vessel wherein the two materials (sulfur trioxide gas and barium hydroxide) are brought into contact one with the other for a recombination reaction. This recombination reaction is needed because both products of the thermal decomposition are harmful to humans and to the environment, but the aqueous barium sulfite resulting from their recombination (in the presence of water) is harmless due to its extremely low solubility.

Barium hydroxide, in addition to having a toxic heavy metal content, is strongly alkaline. As a result, the sulfur trioxide reacting with water immediately creates sulfuric acid, a strong and toxic acid. This reaction can occur in a human lung if sulfur trioxide is inhaled. Embodiments of the method of the present invention include the step of providing a reactor vessel for recombining and reacting the soluble products. The recombination reaction vessel should be sized to provide sufficient residence time and continuous mixing of reactants (or intermediate reactants) to promote the reaction that renders the otherwise toxic materials harmless.

In one embodiment of the method of the present invention, barium sulfate is thermally decomposed at temperatures around 1800-2000 K using laser light impingement, and the thermally decomposed melted barium sulfate. is reacted with reducible carbon or hydrogen (or any hydrocarbon decomposition products formed at the given temperature) according to: BaSO₄+4C→BaS+4CO. The resulting carbon monoxide is liberated from the reaction environment in a gas phase while the BaS is slightly soluble in water. As a result, the BaS can be removed from the pipe and to, for example, a reaction vessel by introducing a flow of water to dissolve the BaS. The resulting products are toxic to humans and will pollute the environment if released, so an oxidative post-treatment is needed. CO-containing gases can be oxidized by burning them in the presence of oxygen to produce carbon dioxide gas, while the barium sulfide can be precipitated from the water with ferrous sulfate, for example, and in insoluble form can be disposed of in a reactor vessel according to: BaS+FeSO₄→BaSO₄+FeS.

Embodiments of the method of making an insoluble alkaline earth metal salt scale material soluble or partially soluble requires the step of heating the material above the thermal decomposition temperature of the material. It should be noted that there is no need to fully dissolve sediments contaminated with other different materials (e.g., silicates or oxides). Removal of scale deposit is critical, and it is sufficient to make soluble only those alkaline earth metal salts that cement the scale in place on the interior wall of the affected pipe, and to thereby form an aqueous suspension in which the particle size is sufficiently small so that the resulting relatively rapid flow through the bore of the pipe will bring the particles to the surface.

As laser light impingement heats the scale deposit to the thermal decomposition temperature, a chemical transformation takes place. Products are liberated in the gas phase, and other products remain as hot and molten or partially molten rock-like deposits. These remaining products are contacted with water or an aqueous solution to partially or hilly dissolve the remaining deposits and to thereby form an aqueous suspension. The strongly alkaline metal hydroxide products (or interim reactants) facilitate the dispersion of the remaining unreacted and insoluble salt particles and stabilizes the resulting suspension because the high concentration of hydroxide ions imparts a strongly negative charge to the surface of the insoluble salt particles. The resulting electrostatic repulsion forces enable the (charged) particles to be easily removed one from the others (dispersion) and adhesion of the salt particles is inhibited by stabilization of the suspension.

The above-mentioned steps can occur in a purely aqueous phase and also in multi-phase oil-aqueous fluid systems. The hydrophobic oil phase, however, affects the system because oil has a relatively low surface tension. As a result, an oil film tonus on the wall of gas bubbles occurring in the liquid phase, and the oil film impairs the transport of substances in the gas phase (i.e. in the bubbles) to the liquid phase. An example of this impairment of reactivity of a gas phase is the dissolution of sulfur trioxide and its transformation into sulfuric acid. Smelting and chemical breakdown resulting from laser light irradiation must be performed in a non-laser obstructing gaseous atmosphere so that boiling liquids present in the reaction environment do not leach and remove the energy needed for vaporization and/or thermal decomposition of components of the scale deposit. The partially molten deposition material in a hot gas-phase is preferably washed with water or an aqueous solution off of the interior wall of the pipe and into the liquid phase in the gas-filled pipe section to be cleaned, The liquid and vapor phases then need to be drained at such a rate from the pipe section to be cleaned that the suspended solid particles cannot settle out of the suspension. In order to implement the chemical breakdown, melting and dissolving, cyclic heating is applied, followed by an aqueous dilution and wash. A possible implementation of this method is illustrated by, but not limited for the following examples.

In a first embodiment and example, an environment free of laser-obstructing material is provided by introducing an inert gas into the pipe section to be cleaned while the liquid in the pipe is isolated to the remainder of the pipe. In the inert gas environment, a laser head having a plurality of laser elements is activated to irradiate and to rapidly heat the scale deposit to a thermal decomposition temperature. Advantageously, the highly conductive metal pipe is cooled by rapid conduction to a large heat sink (e.g. the remainder of the pipe) and/or cooled using water so that it remains undamaged by any contact with the laser light, which is preferably in the infrared wavelength range. The significantly less conductive scale deposit (as compared to the pipe wall) heats up rapidly, then melts and/or partially thermally decomposes. Ports in the laser head 4 may contain the laser elements from which laser light is emitted onto the scale deposit, and other or the same ports in the laser head 4 facilitate the introduction of inert gas streams or inert gas jets to displace laser-obstructing materials from the pipe section to be cleaned. One or more other ports in the laser head 4 facilitate the introduction of water into the pipe section to be cleaned. The laser head 4 is rotatable to create a generally rotating gas bubble about an axis of the laser head 4, and a jet of water is introduced after laser light irradiation of the scale deposit to provide cooling and dissolving of remaining thermally decomposed solids in the pipe section to be cleaned. While the initial dissolving of thermally decomposed scale deposit material begins with the introduction of a stream of cooling water through one or more ports in the laser head 4, it will continue and be completed by the flow of water provided to the pipe section in the subsequent step of the method. The resulting oil-water-gas-solid particle mixture is then transported from the cleaned pipe section by the flow of water.

In a second example and embodiment of the method, the upper part of the pipe receives a water-tight seal with the help of a sealing device, for example, an inflatable packer or other barrier coupled to the laser head that is inserted into the bore of the pipe to be cleaned of scale deposits. Liquid is displaced from the section of the pipe to be cleaned of solid deposits, and a pipe having a diameter smaller than the scale-narrowed pipe section provides a flow. The pipe may be one of a plurality of conduits provided within an umbilical that is used to position the laser head and to provide laser light, water and inert gas to the laser head. A discharge conduit within the umbilical is used to remove water, including the wash water provided to the pipe section to be cleaned, and the original oil-water mixture from the pipe section to be cleaned, it will be understood that upon filling the pipe section to be cleaned with non-laser obstructing gas, some of the gas will also be removed from the pipe section to be cleaned along with the wash water and the original oil-water mixture. Instead of a rotating laser head, the scale deposit is irradiated by sequentially activating and deactivating laser light fibers in the umbilical that teed laser light to and cause light to be emitted from laser light emitting elements in the laser head. Sequencing the activation and deactivation of the laser light emitting elements enables a controlled laser light irradiation of the scale deposit to be achieved without the use of rotating elements in the laser head. Eliminating the rotating elements in the laser head reduces the likelihood of mechanical failures in the laser head.

An appropriately designed recombination vessel is provided for implementing the subsequent step of recombining products (intermediate reactants) of the irradiation step. More specifically, the recombination vessel is adapted to promote the recombination of sulfuric acid, resulting from the reaction of sulfur trioxide liberated in a gas phase and water (see above discussion of reaction involving sulfur trioxide and water), and dissolved alkaline earth metal ions to react and form (or to re-form) the material of which the original scale deposit was comprised. Due to the high binding, energy involved, the precipitate forms very small, near colloidal-sized particles which can move easily with the liquid phase. In one embodiment of the method, the reaction vessel is arranged so that a precipitating and disposal reaction section of the recombination vessel is formed directly above a section for dissolving and removing the scale deposits. In this embodiment, the precipitation chamber can be reached through very short transport from the pipe section to be cleaned to the recombination vessel. In instances where the presence of an oil-water mixture causes oil film coating, of gas bubbles, the hydrophobic hydrocarbon film cover on the phase boundary of the gas and liquid phase of the oil-water-gas-solid particle mixture can be penetrated by providing intense mixing and highly turbulent flow in the recombination vessel. It will be understood that agitators can be provided for this purpose. Absent mixing and turbulent flow, the desired reaction in the recombination vessel may not occur to the fullest extent possible. Continued mixing and turbulence serve to ensure that small, solid-phase particles do not re-connect or recombine in the form of unwanted precipitates in the recombination vessel. Certain chemicals can be introduced to impair the adhesion of the small, solid particles. For example, adding a small amount of a surface-active additive, e.g. alkyl sulfonate, can impair such unwanted adhesion and will keep the recombination vessel operable. Note that in the given system, if a long carbon-chain, unsaturated hydrocarbon reacts with sulfur trioxide in high temperature, the alkyl sulfonates can also be formed on-site. For example, if an embodiment of the method of clearing, scale deposits is performed in a production tubing in a hydrocarbon-producing well, such hydrocarbons will surely occur in the mixture and hydrocarbons will react with the sulfur trioxide, CH₃—(CH₂)ₙ—CH₃+SO₃=CH₃—(CH₂)ₙ—CH₂—SO₃H, where n is an integer number between 0 and 30, which implies that there will be hydrocarbons of different molecular size in the system. The product of this reaction in an alkaline solution which has the same properties as the alkyl sulfonate mentioned above.

In another embodiment of the method of the present invention, the recombination vessel is provided high above the laser head 4 and, in one embodiment, on the surface of the earth. This allows the recombination vessel to be easily cleaned for dissolving and removing the deposits, even on the surface. The main advantage of this embodiment is that the deposits that may be generated during the recombination step are easily removable from the recombination vessel using manual access, and the recombination vessel will remain easy to access, maintain and clean. A disadvantage of this method is that, in the case of an oil-water-gas-solid particle mixture, the mixture must travel a relatively long distance from the laser bead 4 or the initial irradiation environment to the recombination vessel without reacting to the extent of formation of secondary precipitates in the pipe. The slow rate of recombination and precipitation is due to the fact that the hydrocarbon film covering the phase boundary impairs contact between the gases (such as sulfur trioxide) and the water thus, in case of a more stable bubble structure, they can be transported a long way without reaction or change.

The composition of the phases will be a factor to be considered in choosing from the above-described embodiments of the method. It will be understood that the embodiment of the method to be employed can be selected on the basis of the extent to which secondary scale deposits occur in the preferred environment, such as a recombination vessel.

Embodiments of the method of removing alkaline earth metal salt deposits from a pipe, such as a pipeline or a production tubing, includes the steps of introducing a laser head into the bore of the pipe, positioning the laser head at a pipe section to be cleaned, introducing an inert gas into the pipe section to be cleaned adjacent to the surface layer of the solid alkaline earth metal salt deposit, irradiating a surface layer of a solid alkaline earth metal deposit on an interior wall of the pipe section to be cleaned to heat to thermally decompose at least a component of a surface layer of the solid deposit and to thereby liberate a gas phase as a result of the thermal decomposition of the at least a component of the scale deposit, introducing a stream of liquid to remove a remaining thermally decomposed portion of the scale deposit. In this embodiment of the method, the surface layer of the solid alkaline earth metal salt deposition is heated above the thermal decomposition temperature of at least a component of the irradiated scale deposit, and the molten and/or thermally decomposed layer of scale is converted, at least partially, into a soluble material by means of superheating, and the remaining solid portion of the thermally decomposed scale deposit becomes water-soluble and/or water-suspendable solid particles that can be washed out oldie pipe section to be cleaned using a stream of water or an aqueous solution that enables the resulting solution and/or suspension to be removed from the pipe section to be cleaned with a speed that prevents recombination of products of the irradiation step (interim reactants) and reformation and re-adherence of the scale deposit.

In a further preferred embodiment of the method, the liquid phase and the gas phase resulting from the irradiation step and the washing step are removed from the pipe section to be cleaned through a discharge conduit within the umbilical and terminating at the laser head.

In a further preferred embodiment of the method, intensive agitation or stirring is applied to the contents of the pipe section to be cleaned while the products of the irradiation step and the products of the washing step are removed via a discharge conduit within the umbilical and terminating at the laser head.

The embodiments of the method of the present invention may be implemented by an apparatus that includes an umbilical comprising a plurality of laser light-conducting optical fibers and a plurality of conduits therein and terminating at a laser head comprising a plurality of laser elements for emitting laser light onto a scale deposit adhered to the interior wall of a pipe section to be cleaned. The laser head further comprises an expandable packer that is deployable from a retracted configuration, to allow positioning of the laser head along the bore of the pipe section to be cleaned, to an expanded configuration to seal against the interior wall of the pipe. At least one of the conduits of the umbilical comprises a gas conduit. An inert gas is delivered through the gas conduit to the pipe section to be cleaned after deployment of the packer. After the introduction of the inert gas creates a favorable environment for laser transmission in the pipe section to be cleaned, laser elements in the laser head are activated. Upon activation of the laser elements, laser light impinges on the scale deposit to melt and/or thermally decompose at least a cementing component of an alkaline earth metal salt scale deposit while the packer seals the environment in the pipe section to be cleaned adjacent to the alkaline earth metal salt deposition from the fluids in the remaining, portion of the pipe opposite the packer. Irradiation of the scale deposit melts and/or thermally decomposes at least a component of the scale deposit. At least one of the conduits of the umbilical comprises a conduit for delivering water or an aqueous solution to wash the remaining, thermally decomposed portion of the irradiated scale deposit.

According to a preferred embodiment of the apparatus that can be used for implementing embodiments of the method of the present invention, the deployable packer is inflatable. In one embodiment, the gas conduit can be pressurized to both deploy the packer to seal against the interior wall of the pipe and to introduce gas into the pipe section to be cleaned to displace laser-obstructing materials. In a further preferred embodiment of the apparatus, the laser head comprises a symmetric conical or tapered element. In a further preferred embodiment of the apparatus, the discharge conduit is a conduit that is concentrically centered along an axis of the laser head formed as a symmetrically-shaped conical structure. In a further preferred embodiment of the apparatus, the conical or tapered portion of the laser head has a 2-60 degree angle, preferably a 45 degree angle, with laser emitting elements and gas-emitting elements along the angled face of the laser head.

In one embodiment of the apparatus, the laser head is fixed against rotation, and the laser emitting elements and the gas ports on the angled face of the laser head are intermittently activated. In another embodiment of the apparatus, the laser head is rotatably mounted at an end of the umbilical to rotate about an longitudinal axis, and the laser emitting elements and the fluid ports are formed only on one portion of the laser head. In an embodiment of the apparatus, a video camera is incorporated into the laser head to transmit, either wirelessly or through a wire or optical fiber in the umbilical, images of the scale deposit in the pipe section to be cleaned.

### BRIEF DESCRIPTION OF THE DRAWINGS

An embodiment of the present invention will hereinafter be described in more detail with references to the accompanying drawings, which include embodiments of the apparatus described above for implementing embodiments of the method of the present invention, In the drawings:

FIG. 1 is an elevation view of an embodiment of a laser head being used to implement an embodiment of the method of the present invention.

FIG. 2 is an elevation view of an embodiment of a laser head having a partition member and being used to implement an embodiment of the method of the present invention.

FIG. 3 is a partially sectioned perspective view of the laser head of FIG. 1 disposed within a pipe adjacent to a pipe section to be cleaned of a scale deposit.

FIG. 4 is a partially sectioned perspective view of the laser head of FIG. 2 disposed within a pipe adjacent to a pipe section to be cleaned of a scale deposit.

### DETAILED DESCRIPTION

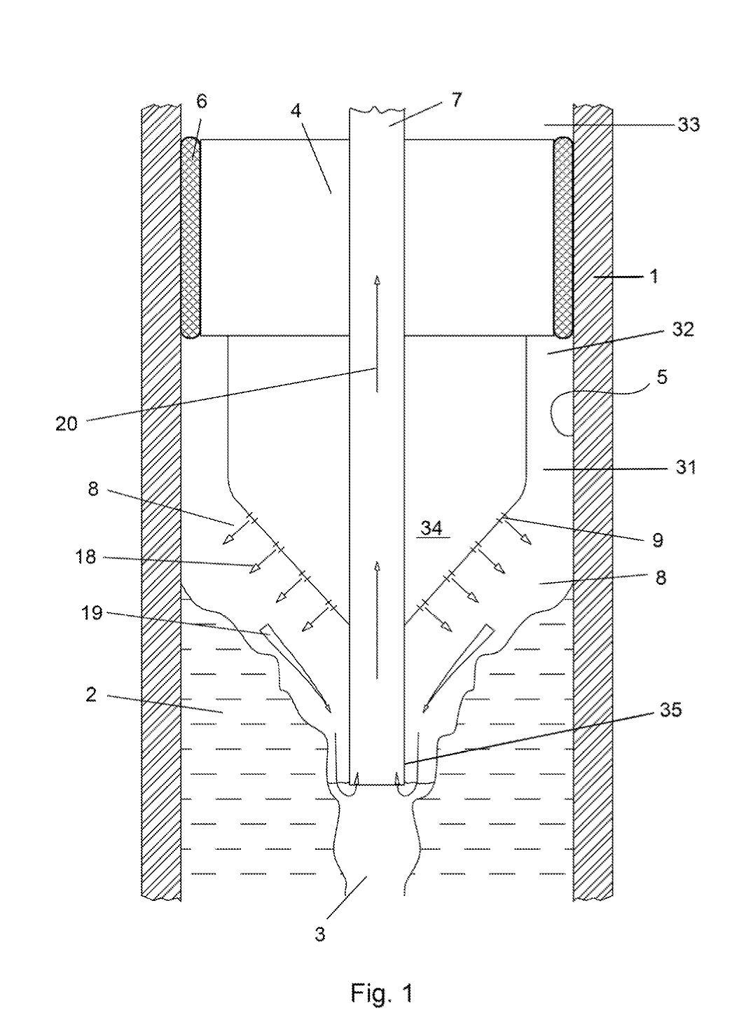

FIG. 1 is an elevation view of an embodiment of a laser head being used to implement an embodiment of the method of the present invention for removing a solid salt deposit 2 from an interior wall of a pipe 1. The solid, salt deposit 2 is illustrated in FIG. 1 as plugging a substantial portion of an interior bore 31 of the pipe 1. The fluid flowing; through the bore 31 of the pipe 1 may comprise, for example, oil, water, gas condensate and/or hydrocarbon derivatives. Sit will be understood that the formation of the solid salt deposit 2 narrows the bore 31 and reduces the flow area and, as a result, the flow capacity of the pipe 1. It will be further understood that the deposition of the solid salt deposit 2 impairs the flow of the fluid and, without remedial measures to restore flow capacity, will eventually block the bore 31 of the pipe 1.

One embodiment of the method of the invention comprises the step of providing a laser head 4 into the bore 31 of a pipe 1. The laser head 4 has a diameter that is smaller than the bore 31 of the pipe 1. The laser head 4 is connected to an umbilical (not shown) and movable within and along the length of the pipe bore 31 by feeding out and reeling in the umbilical.

An inflatable packer member 6 is coupled to the laser head 4 and inflates from a retracted mode, enabling the laser head 4 to be positioned along the bore 31 of the pipe 1, to an expanded mode to circumferentially engage and seal with the interior wall 5 of the pipe 1. Expandable deployment of the packer 6, through fluid pressure provided through, a conduit (not shown) within the umbilical, seals a first portion 32 of the pipe bore 31 on a first side of the deployed packer 6 from a second portion 33 of the pipe bore on the opposite side of the deployed packer 6.

In the embodiment illustrated in FIG. 1, the laser head 4 has a leading portion 34 with a conical or tapered shape. A discharge conduit 7 emerges from the umbilical (now shown) and passes through the laser head 4. The discharge conduit 7 terminates at a proximal end 35 disposed in FIG. 1 below the conical or tapered portion 34 of the laser head 4. A distal end of the discharge conduit 7 is maintained at a pressure below the pressure in the pipe 1 at the laser head 4 to enable the discharge conduit 7 to receive, transport and deliver material from the pipe section to be cleaned 8 to a receiving vessel (not shown) maintained, for example, at or on the earth's surface.

In one embodiment, the laser head 4 comprises a conical or tapered portion 34 having a 2 degree to 60 degree angle. For example, FIG. 1 illustrates a laser head 4 having a conical or tapered portion with a 45 degree angle.

FIG. 1 illustrates a plurality of openings 9 in the conical or tapered portion 34 of the laser head 4. A first purpose of the openings 9 is to direct laser light into the pipe section to be cleaned 8, as indicated by the arrows 18 indicating the direction and path of laser light emitted from each of the openings 9. A second purpose of the openings 9 is to direct non-laser obstructing expanding gas streams into the pipe section to be cleaned 8, as also indicated by the arrows 18 indicating the direction and path of the non-laser obstructing fluid streams released through each of the openings 9A. third purpose of the openings 9 is to direct a stream of water into the pipe section to be cleaned. It should be understood that the openings 9 may, in one embodiment, serve as a port through which laser light passes from a laser emitting element to impinge on a scale deposit 2, and as a port through which gas passes to displace laser obstructing materials from the pipe section to be cleaned 8 and as a port through which liquid water passes to wash a thermally decomposed scale deposit 2. Alternately, openings 9 may serve as a port for only laser light, gas or water, or any combination of these.

It will be understood that the laser light entering the pipe section to be cleaned 8 will, absent a non-laser obstructing medium in the pipe section to be cleaned 8, impinge upon, irradiate and heat the scale deposit 2. It will be further understood that the streams of non-laser obstructing fluid entering the pipe section to be cleaned 8 will cause any laser-obstructing medium in the pipe section to be cleaned 8 to be displaced in the direction of the arrows 19 and to be withdrawn, along with the flow of gas, from the pipe section to be cleaned 8 into and through the proximal end 35 of the discharge conduit 7.

It will be understood that the fluid(s) originally transported using the pipe 1 (and involved in the scale deposition) will enter the pipe section to be cleaned 8 through the remaining channel 3 in the scale deposit 2. For example, but not by way of limitation, if the pipe 1 is used to transport oil and water, then oil and water may enter the pipe section to be cleaned 8 by way of the channel 3. It will be understood that, depending on the nature and character of the fluid(s) transported using the pipe 1, removal of the invasive fluid(s) from the pipe section to be cleaned 8 may be needed.

The discharge conduit 7 may be operated to remove invasive fluid(s) that may enter the pipe section to be cleaned 8. A pressure differential between the pressure in the pipe section to be cleaned 8 and the distal end 35 (not shown) of the discharge conduit 7 causes fluid(s) in the pipe section to be cleaned 8 to he drawn into the discharge conduit and transported through the discharge conduit 7 to a vessel (not shown) to which a distal end (not shown) of the discharge conduit 7 is connected, It will be understood that the deployment of the packer 6 to engage and seal with the interior wall 5 of the pipe 1 isolates the pipe section to be cleaned 8 from the portion 33 of the bore of the pipe 1 above the packer 6 in FIG. 1. As a result, expanding gas within the pipe section to be cleaned 8 that is heated by the laser light 18 enters the proximal end 35 of the discharge conduit 7 and is thereby removed from the pipe section to be cleaned 8. Also, some fluid(s) that would otherwise enter the pipe section to be cleaned 8 from the channel 3 will also enter the proximal end 35 of the discharge conduit 7.

Exposing the scale deposit 2 to the laser light emitted through the openings 9 on the laser head 4 causes a surface layer of the scale deposit 2 to be heated to a thermal decomposition temperature of at least one component of the scale deposit 2. However, the purpose of heating the surface layer of the scale deposit 2 to the thermal decomposition temperature of the at least one component of the scale deposit 2 is not to vaporize or to evaporate the scale, but to remove a molten and/or decomposed layer of scale deposit 2 from the interior wall 5 of the pipe 1 and into the flow of the non-laser obstructing fluid introduced into the pipe section to be cleaned 8 through the openings 9 and entering the proximal end of the discharge conduit 7, as illustrated by the arrows 19. The surface layer of the scale deposit is dissolved, dispersing it with the liquid medium, such as water introduced via the same openings 9 in the laser head 4 into the pipe section to be cleaned 8.

The scale deposit material that is melted and/or otherwise decomposed off of the interior wall 5 of the pipe 1 or suspended scale deposit 2 elements are removed from the pipe section to be cleaned 8 through the discharge conduit 7 and in the direction indicated by the arrows 20, together with the fluid and a gas phase, at such speed that the molten and/or decomposed components of the scale deposit 2 do not recombine in the pipe 1. In one embodiment, the molten and/or thermally decomposed components of the scale deposit 2 are removed, transported and then recombined in a controlled environment. The speed with which the molten and/or thermally decomposed components of the scale deposit 2 must be removed and/or transported can be empirically determined, and in the actual application environment the corresponding range of values can be experimentally found and determined.

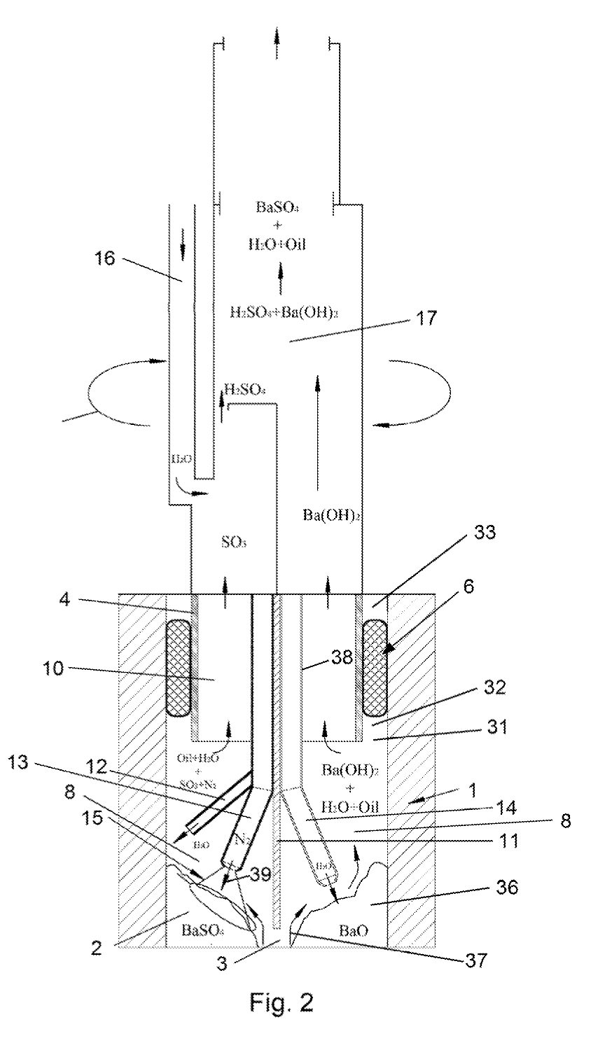

FIG. 2 illustrates an embodiment of the apparatus and method of the present invention for removing a BaSO₄ scale deposit 2 from the interior wall S of a pipe 1 and for removing a BaO scale deposit 36 from the interior wall of a pipe 1. It will be understood that a scale deposit 2 may comprise BaSO₄ or BaO, or both, and that the use of the illustration in FIG. 2 is not meant to suggest that these materials occur exclusively of the other. FIG. 2 illustrates chemical reactions that may occur during the process of removing scale deposits 2 and 36 of known compositions using embodiments of the apparatus and method of the present invention. The laser head 4 illustrated in FIG. 2 is of a different type than the embodiment of the laser head 4 of FIG. 1

In the example illustrated on the left side of FIG. 2, a BaSO₄ scale deposit 2 is adhered to the interior wall 5 of the pipe 1. Oil or an oil water mixture 37 flows upwardly through the channel 3 through the scale deposit 2 and into the pipe 1. There is a laser head 4 introduced into the bore 31 of the pipe 1. The laser head 4 is provided with a packer 6 that is inflated from a retracted configuration to an expanded configuration that is illustrated in FIG. 2. The packer 6, when in the expanded configuration, seals off a portion of the bore of the pipe 1 above the packer 6 from a portion 32 of the bore 31 of the pipe 1 below the packer 6 as illustrated in FIG. 2. It will be noted that the laser head 4 of FIG. 2 does riot include a discharge conduit 7 terminating immediately below the laser head 4. The laser head 4 of FIG. 2 comprises an annular conduit 10 concentrically surrounding a conduit bundle 38 near the center of the laser head 4. The annular conduit 10 is provided for the removal of materials from the portion 32 of the bore of the pipe 1 disposed below the packer 6, including, but not limited to, certain chemical products as discussed in more detail below.

The conduit bundle 38 in the center of the laser had 4 contains a combined laser element/inert gas conduit 13 to emit a beam of laser light 15 to impinge onto a scale deposit 2 and to supply a stream 39 of inert gas from a pressurized gas source (not shown) connected to a distal end (not shown) of the gas conduit 13 to the proximal end of the gas conduit 13 shown in FIG. 2. Inert gas, such as nitrogen gas, from the pressurized gas source (not shown) flows through the gas conduit (now shown) to the proximal end of the combined inert gas nozzle and laser element 13 and is released into the portion 32 of the bore 31 of the pipe 1 below the packer 6 to displace laser-obstructing materials from the laser path 15 intermediate the laser head 4 and the scale deposit 2. The combined inert gas nozzle and laser element 13 introduces inert gas onto the scale deposit 2 and into the pipe section to be cleaned 8 below the laser head 4 in FIG. 2. A water conduit 12 on the laser head 4 supplies a stream of liquid water to cool the interior wall 5 of the pipe 1. The number of laser light beams 15, their scope and direction, can be freely determined based on the actual size of the pipe 1 and the position of the scale deposit 2, or where appropriate, can be controlled, directed from the distal end of the umbilical (not shown), which can be on the earth's surface.

As a result of the process, oil+water+SO₃+N₂ will flow upward in the pipe section to be cleaned 8 and, with the water introduced through the channel 3 below the laser head 4, SO₃ can be reacted to form H₂SO₄, or sulfuric acid.

FIG. 2 illustrates a partition wall 11 extends down from the laser head 4 to separate chemical compounds generated at stages of the above described scale removal operation. It will be understood that using laser light to thermally decompose a scale deposit 2 comprising BaSO₄ will produce one or more products (or interim reactants) while using laser light to decompose a scale deposit 36 comprising BaO will produce one or more products (or interim reactants) of another type and requiring a different type of handling or treatment. It is important to handle or treat the products of the laser irradiation step (or interim reactants) in a manner that prevents reformation of scale deposits in the pipe 1.

Accordingly, in the right side of FIG. 2 a stream of water is provided from the laser head 4 through a water conduit 14 on the right side of the partition 11 to impinge on the scale deposit 36 comprising BaO that has already been thermally decomposed using laser light. As a result of the thermal decomposition using laser light, the chemical composition of the BaO scale 36 has been modified. Water from the water conduit 14, oil 37 and thermal decomposition products resulting from the irradiation of the BaO scale deposit 36 including, but not limited to Ba(OH)₂, and further including insoluble salt particles, flow upward into the annular conduit 10 of the laser head 4 into the reaction area 17. In the reaction area 17 above the range of the laser head 4, the arriving materials react to form a mixture of oil, BaSO₄ and H₂O, which materials do not pose an environmental hazard. These materials can be removed from the reaction area 17 and safely separated, dumped and/or stored.

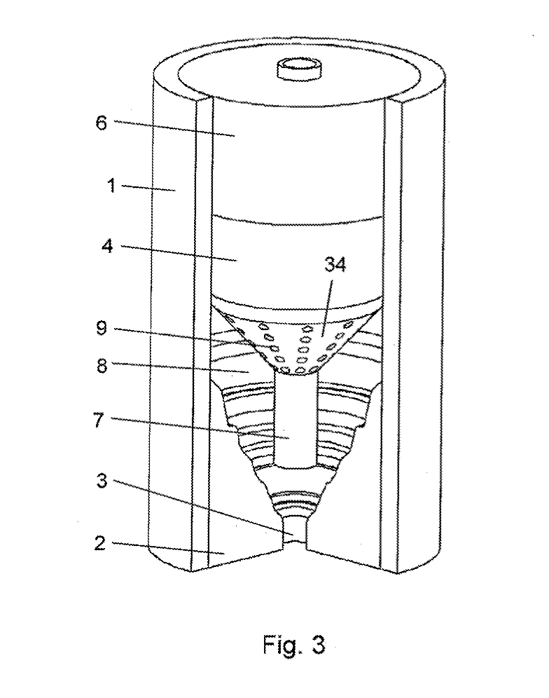

FIG. 3 is a partially sectioned perspective view of the laser head 4 of FIG. 1 disposed within a pipe 1 adjacent to a pipe section to be cleaned 8 of a scale deposit 2.

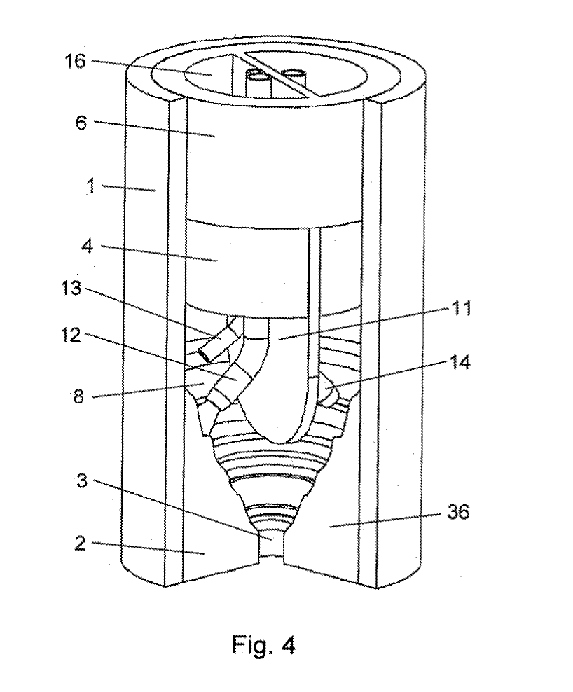

FIG. 4 is a partially sectioned perspective view of the laser head 4 of FIG. 2 disposed within a pipe 1 adjacent to a pipe section to be cleaned 8 of a scale deposit 36.

The laser head 4 illustrated in FIG. 3 includes openings 9 at a conical or tapered portion 34 of the laser head 4. The openings 9 are disposed on the tapered portion 34 in several rows extending along the laser head 4. The removal of the scale deposit 2 from the pipe section to be cleaned 8 happens simultaneously over the whole cross-section of the pipe 1. This means that the laser head 4 is moved only along the bore of the pipe 1; it is not necessary to turn or rotate the laser head 4 about an axis.

In contrast, FIG. 4 illustrates a different embodiment of a laser head 4 that can be used for carrying out the process relating to FIG. 2. in FIG 4 the conduits 12, 13, and 14 emerge from a conduit bundle 38 (not shown in FIG. 4—see FIG. 2) and generally occupy a center of the laser head 4. The laser head 4 of FIG. 4 and FIG. 2 further includes a partition wall 11 and an annular conduit 10 disposed around the conduit bundle 38 (not shown in FIG. 4—see FIG. 2). The laser head 4 of FIG. 4 is rotatable about an axis, and the combined inert gas/laser emitting elements 15 (not shown in FIG. 4—see FIG. 2) and their associated openings 9 are harmed in only one peripheral portion of the laser bead 4. The size of that section is also affected by the required temperature, and the fluid volume to be disposed. For the rotation of the laser head 4 about the axis, a device of known structure and action can be used, for example, a motor.

In one embodiment of the apparatus of the present invention, a camera element is provided to sense images of the interior wall of the pipe section to be cleaned 8 and to transmit the images to a display device for viewing. In one embodiment, the camera element is connected to the display device by a conductive element such as a wire. In another embodiment, the camera element is wirelessly connected to the display device using a transmitter connected to the camera element and a receiver connected to the display device.

In one embodiment of the apparatus of the present invention, a spectroscopic sensor is provided to sense the spectroscopic characteristics of light generated during thermal decomposition of irradiated scale deposits on the interior wall of the pipe section to be cleaned 8 and to transmit data to a monitor. In one embodiment, the spectroscopic sensor is connected to the monitor by a conductive element such as a wire. In another embodiment, the spectroscopic sensor is wirelessly connected to the monitor using a transmitter connected to the spectroscopic sensor and a receiver connected to the monitor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method to remove an alkaline earth metal salt scale deposit from an interior wall of a pipe, comprising:
providing a laser head having an expandable packer member, one or more laser emitting elements, a gas port and a liquid port within a bore of the pipe and proximal to the scale deposit;
deploying the expandable packer member to isolate a first portion of the pipe containing the scale deposit from a second portion of the pipe;
introducing a volume of non-laser obstructing gas through the gas port and into the second portion of the pipe adjacent to the scale deposit to displace laser-obstructing materials from a laser light path intermediate the laser head and the scale deposit;
activating the one or more laser emitting elements in the laser head to transmit laser light across the laser light path and to impinge laser light onto the scale deposit;
irradiating the surface layer of the scale deposit to heat at least a portion of the scale deposit to a thermal decomposition temperature; and
introducing, a flow of water through the liquid port and onto the thermally decomposed scale deposit;
wherein one or more components of the thermally decomposed scale deposit become at least partially soluble as a result of being, heated by irradiation with the laser light; and
wherein one or more components of the thermally decomposed scale deposit become less cohesive as a result of thermal decomposition.

2. The method of claim 1, further comprising:
providing a recombination vessel;
introducing the decomposition products resulting from the thermal decomposition of the scale deposit into the recombination vessel;
precipitating at least a portion of the scale deposit in the recombination vessel.

3. The method according to claim 2, further comprising:
providing a discharge conduit proximal to the pipe section to be cleaned of the scale deposit; and
receiving into an end of the discharge conduit at least some of the products of the thermal decomposition of the scale deposit, at least some of the gas introduced through the gas port, and at least some of the water introduced through the liquid port, from the pipe section to be cleaned to thereby remove these materials from the pipe section to be cleaned.

4. The method of claim 3, further comprising:
turbulently mixing the materials received into the end of the discharge conduit.

5. he method of claim 1, further comprising:
retracting the packer member; and
advancing the laser head along the bore of the pipe to reposition the laser head adjacent to a second scale deposit.

6. The method of claim 1, wherein:
the one or more less cohesive components of the thermally decomposed scale deposit are suspended and removed from the interior wall of the pipe by the flow of liquid introduced through the liquid port.

7. The method according to claim 1, wherein:
one or more components of the scale deposit melt upon being heated to the thermal decomposition temperature.

8. The method according to claim 1, wherein:
the pipe comprises production tubing in a well drilled into the earth's crust.

9. The method according to claim 1, wherein:
the pipe comprises a pipeline.

10. An apparatus for being received into a bore of a pipe to remove a scale deposit on the interior wall of the pipe, comprising:
a tapered leading portion having at least one gas port connected to a source of pressurized gas, at least one liquid port connected to a source of pressurized water, and at least one laser emitting element connected to a laser light source;
a radially expandable packer member deployable from a retracted. configuration that permits positioning of the apparatus within the bore of the pipe to an expanded configuration to engage and seal against the interior wall of the pipe; and
a discharge conduit having an end to receive materials from a pipe section proximal to the tapered leading, portion;
wherein the at least one laser emitting element is activatable to irradiate, heat and thermally decompose scale deposits in a pipe section to be cleaned using the apparatus;
wherein the at least one gas port introduces non-laser obstructing gas into the pipe section to be cleaned to displace laser obstructing materials from a laser light path intermediate the laser emitting element and the scale deposits in the pipe section to be cleaned;
wherein the at least one liquid port introduces water into the pipe section to be cleaned to wash the thermally decomposed scale deposits; and
wherein the discharge conduit receives and removes materials resulting from thermal decomposition and washing of the scale deposits.

11. The apparatus of claim 10, wherein the packer member is inflatable from the retracted configuration to the expanded configuration.

12. The apparatus of claim 10, wherein the tapered leading portion is generally conical about an axis of the apparatus.

13. The apparatus of claim 12, wherein the discharge conduit is disposed along the axis of the apparatus.

14. The apparatus according to claim 13, wherein the end of the discharge conduit extends beyond the tapered leading portion.

15. The apparatus according to claim 4, characterized in that the tapered leading portion of the apparatus comprises an angle within the range of two to sixty degrees to position the laser emitting element for impingement of laser light emitted therefrom onto the interior wall of the pipe.

16. The apparatus of claim 10, further comprising:
a motor operable to rotate the tapered leading portion of the apparatus;
wherein rotation of the tapered leading portion moves the laser light path about an axis of the apparatus.

17. The apparatus of claim 10, wherein the at least one laser emitting element comprises a plurality of laser emitting elements distributed about a face of the tapered leading portion; and
wherein the plurality of laser emitting elements are intermittently activatable.

18. The apparatus of claim 10, further comprising:
a camera element electronically connected to a display device to provide images of the interior wall of the pipe for viewing.

19. The apparatus of claim 18, wherein the camera element is connected by a conductive wire to a display device.

20. The apparatus of claim 18, wherein the camera element is wireless connected to a display device.

21. The apparatus of claim 10, further comprising:
a spectroscopic sensor connected to provide a signal indicating a spectroscopic character of light emitted during thermal decomposition of irradiated scale deposits.
